(19) United States
(12) Patent Application Publication
(10) Pub. No.: US 2003/0110386 A1
(43) Pub. Date: Jun. 12, 2003

(54) Chip for placing in a terminal

(76) Inventor: Wilhelmus Johannes Bernardus Maria Stolwijk, Utrecht (NL)

Correspondence Address: PEACOCK MYERS AND ADAMS P C, P O BOX 26927, ALBUQUERQUE, NM, 871256927

(21) Appl. No.: 10/255,653

(22) Filed: Sep. 25, 2002

Related U.S. Application Data
(63) Continuation of application No. PCT/NL01/00252, filed on Mar. 27, 2001.

(30) Foreign Application Priority Data
Mar. 31, 2000 (NL) 1014811

(51) Int. Cl. H04L 9/32

(52) U.S. Cl. 713/189

(57) ABSTRACT

A chip suitable for placing in a transaction terminal which may be coupled with a telecommunication network and which terminal is provided with a processor and a memory for carrying out at least one payment function. The chip is designed with an independently active chip processor and a chip memory, which work together and wherein the chip is further provided with an interface which allows the chip processor to communicate with the processor of the terminal.

The invention relates to a chip designed for placing in a transaction terminal, which terminal is provided with a processor and a memory for carrying out at least one payment function. If an online terminal is concerned, the same is connected to a data communication means, for example, a telecommunication network; if an offline terminal is concerned, the data communication network provides contact with, for example, a diskette for storage.

From the prior art terminals are known in the form of machines functioning on the basis of pin transactions or chip card payments. The known transaction terminals are evolved by way of providing potential suppliers with specifications. In practice the result was that on the basis of said specifications a wide diversity in available transaction terminals evolved. A consequence of this is that the quality of the available transaction terminals varies considerably, while the introduction of innovations regarding said transaction terminals, respectively the introduction of new uses or applications is a slow process because all suppliers of existing terminals have to go through a developmental stage before providing such new applications. In addition, the prior art requires that such new applications usually have to be installed on site. The costs are accordingly high.

U.S. Pat. No. 5,036,461 discloses a chip placed in a transaction terminal, which chip is designed with an independently active chip processor and a chip memory, which work together and wherein the chip is further provided with an interface which allows the chip processor to communicate with the processor of the terminal.

It is the object of the invention to further develop the known chip such that the same can operate technically and functionally independently, having a high (absolute) level of security with regard to the data processing to be carried out by this chip. It is further desirable to provide a supplier-independent technique allowing new applications to be introduced quickly and economically such that both existing and new terminals may be similarly supplied with such new applications, and a guaranteed standard of quality may be maintained.

According to the invention this is achieved by the chip having a data bus with a data transmission port coupled thereto, and comprising a separate data processing system connected to the data transmission port, which system has a central processing unit and a working storage coupled thereto, and wherein the data processing system is provided with a cryptographic device for encoding and decoding a data stream maintained via the data bus. This ensures that the chip provides a protected, separate, and secured data processing environment for the actions concentrated in the chip. This relates to secured transactions such as payment functions and will be or may be part of the terminal containing the chip. Because the data processing system is separate, it is able to grow with the technical developments such as to automatically upgrade its arithmetic ability and speed to match that realized at any moment within a certain area of the chip.

Conveniently, the chip is provided with an autonomic clock. This affords the advantage that the data processing speed of the chip can be optimized and that it can be active independent of the terminal surroundings wherein the chip may be placed.

It is further preferred for the chip to be designed with receiving means for receiving from the terminal a program determining the functionality of the chip. In this way it is possible from a central point, for example a host computer, to quickly provide a number of scattered terminals containing the chip with a new application, without the necessity of physical changes to the terminal, or even the necessity of a technician having to come into action.

It is advantageous for the activation of the functionality present in the chip to be controllable by a user of the transaction terminal. In this way the desired function is realized without the user being clearly aware of the fact that this is delegated to the chip contained in the terminal. The functionality may also be controllable by a bank whose client the user is.

This is preferably implemented such that the chip is designed to send data to and receive data via the interface from the periphery of the terminal such as a display and keyboard or reading device, respectively, that is connected to the transaction terminal. The feeding device may be formed by, for example, a magnetic-strip reader or a chip card reader. The chip may, for example via the interface, communicate with the terminal in order to be able to take into account its characteristics.

The invention, moreover, discloses new possibilities for the use of a chip with payment functions in surroundings and circumstances other than are usual up to now. To this end, the chip according to the invention may preferably be placed in a terminal chosen from the group comprising a transaction terminal, a personal computer, a mobile telephone, a settop box, a vending machine, a public transport ticket machine, a utilities metre.

Hereinbelow the invention will be further elucidated by means of an example and with reference to the drawing, which

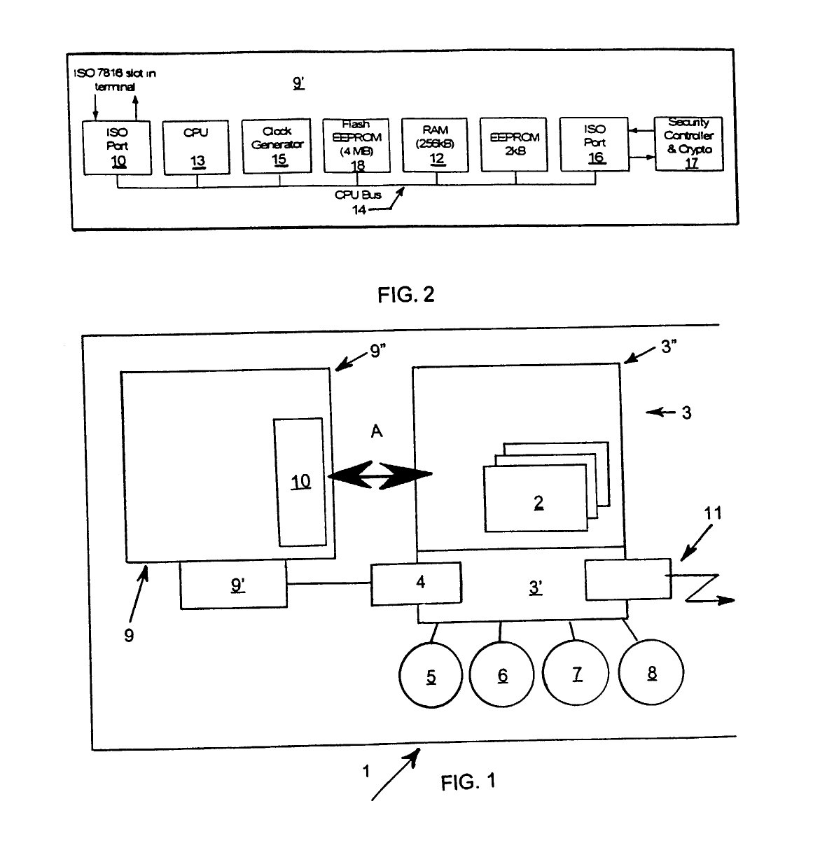

in FIG. 1, schematically shows a terminal containing a chip according to the invention, and

in FIG. 2, shows a schematic representation of the chip according to the invention.

Similar parts in the figures are indicated by identical reference numbers.

FIG. 1 shows a terminal environment indicated by reference number 1 comprising terminal hardware 3′ and terminal software 3″. This terminal environment may accommodate various non-secured applications 2. To the hardware 3′ of the terminal further provisions, known as such, may be connected, i.e. a sam lock 4, a keyboard 5, a chip card reader 6, a magnetic-card reader 7, and a display unit 8. Preferably via the sam lock 4, the terminal 3 is coupled at hardware level 9′ with a chip 9, which is the subject of the present invention. Said chip is designed with an independent chip processor 13 and chip memory 12 (see FIG. 2), which are designed to work together. At software level 9″ the chip is further provided with an interface schematically indicated by arrow A, and which serves for communication of the chip processor 13 of the chip 9 with the processor of terminal 3. The terminal 3 is provided with a specific operating system comprising software drivers for the peripheral equipment mentioned earlier. The chip 9 comprises an interface (or port) 10 for sending and receiving data to and from, for example, the display 8 and keyboard 5, respectively the magnetic strip reader 7 or the chip card reader 6 connected with the terminal 3. Via a data line 11 the chip 9 is able to communicate with a telecommunication network (not shown). In this connection the chip is further equipped with receiving means to allow a programme received by the terminal via the telecommunication network and the data line 11, to be loaded into the chip 9 in order to thereby determine the functionality of the chip 9.

As is shown in FIG. 2, the chip 9 is embodied with a data bus 14 coupled, among others, with the interface 10 which makes communication with the terminal 3 possible. The chip processor 13 mentioned earlier and the chip memory 12 are also connected with this data bus 14. The chip 9 is moreover provided with an autonomic clock 15.

A special feature to be mentioned is a data transmission port 16 connected with the data bus 14, which communicates with a separate data processing system 17. This data processing system 17 in turn comprises a central processing device and a working storage coupled thereto. The chip 9 in the data processing system 17 is preferably provided with a cryptographic device for encoding and decoding a data stream maintained by the chip 9 with the terminal 3, which takes place via the data bus 14, port 10 and the interface channel A. The functionality present in the chip 9 may be controlled via the terminal 3, by means of, for example, operating the keyboard 5, the magnetic stripe reader 7 or the chip card reader 6. In a suitable embodiment, the chip 9 at hardware level 9′ is embodied with a 32-bit processor 13 and is further provided with 256 kB RAM memory 12 and 4-Mb flash EEPROM memory 18. This chip that may be placed in a transaction terminal, is also suitable for placing in a personal computer or a mobile telephone. The chip according to the invention thus discloses new application and payment possibilities unimagined in the prior art and also not available. Not the least reason for this being that the chip format according to the invention is ID-000 (ISO norm 7816).

What is claimed is:

1. A chip designed for placing in a transaction terminal, which terminal is provided with a processor and a memory for carrying out at least one payment function, which chip is designed with an independently active chip processor and a chip memory designed to work together and wherein the chip is further provided with an interface which allows the chip processor to communicate with the processor of the terminal, wherein the chip has a data bus with a data transmission port coupled thereto, and comprises a separate data processing system connected to the data transmission port, which system has a central processing unit and a working storage coupled thereto, and wherein the data processing system is provided with a cryptographic device for encoding and decoding a data stream maintained via the data bus.

2. A chip according to claim 1, wherein the chip is provided with an autonomic clock.

3. A chip according to claim 2, wherein the chip comprises receiving means for receiving from the terminal a program determining the functionality of the chip.

4. A chip according claim 1 wherein the activation of functionality present in the chip is controllable by a user of the transaction terminal.

5. A chip according to claim 4, [characterized in that] comprising means for sending data to and receiving data via the interface a peripheral device connected to the transaction terminal.

6. A chip according to claim 1, placeable in a terminal chosen from the group consisting of a transaction terminal, a personal computer, a mobile telephone, a settop box, a vending machine, a public transport ticket machine, and a utilities meter.
